(19) United States
(12) Patent Application Publication
(10) Pub. No.: US 2026/0309024 A1
(43) Pub. Date: Oct. 8, 2026

(54) CONGLOMERATE RESERVOIR SEGMENTATION AND CLUSTERING METHOD AND APPARATUS, STORAGE MEDIUM, AND PROCESSOR

(71) Applicant: PETROCHINA COMPANY LIMITED, Beijing (CN)

(72) Inventors: Zhenhu LV, Beijing (CN); Linsheng WANG, Beijing (CN); Yupeng ZHANG, Beijing (CN); Shanzhi SHI, Beijing (CN); Jingfeng DONG, Beijing (CN); Weihe WANG, Beijing (CN); Mingwei KONG, Beijing (CN); Jinjun LIU, Beijing (CN); Xiaolu CHEN, Beijing (CN); Hu WU, Beijing (CN); Fushan CHENG, Beijing (CN)

(73) Assignee: PETROCHINA COMPANY LIMITED, Beijing (CN)

(21) Appl. No.: 19/124,395

(22) PCT Filed: Oct. 24, 2023
(86) PCT No.: PCT/CN2023/126270

§ 371 Date: Apr. 25, 2025

(30) Foreign Application Priority Data
Oct. 25, 2022 (CN) 202211312462.8

(51) Int. Cl. E21B 47/09; E21B 47/003

(52) U.S. Cl. CPC E21B 47/09; E21B 47/003; E21B 2200/22

(57) ABSTRACT

Examples of the disclosure provide a method and apparatus for segmentation and clustering of a conglomerate reservoir. The method comprises: performing, by using a clustering analysis algorithm, multidimensional data classification on depth data points of a horizontal well; segmenting a depth of the horizontal well by using a classification result and a preset horizontal segment length; computing, by using an approach degree algorithm, a comprehensive approach degree of geological engineering parameters at depths in segments in a segmentation result, and obtaining a perforation cluster position in the segment; and obtaining a segmentation and clustering result of the conglomerate reservoir according to the segmentation result and the perforation cluster position. Identification accuracy of an engineering sweet spot is improved, balance of geological engineering parameter distributions at a perforation point in the segment is effectively improved, construction difficulty is reduced, and oil and gas well production is increased.

### CROSS REFERENCE TO RELATED APPLICATIONS

The disclosure claims the rights and benefits of Chinese Patent Application 202211312462.8 filed on Oct. 25, 2022, which is incorporated herein in its entirety by reference.

### FIELD OF THE INVENTION

The disclosure relates to the technical field of oil and gas production increase, in particular to a method for segmentation and clustering of a conglomerate reservoir, an apparatus for segmentation and clustering of a conglomerate reservoir, a machine-readable storage medium, and a processor.

### BACKGROUND OF THE INVENTION

The Mahu sag in Junggar basin is a large hydrocarbon-rich sag featuring multi-layer system reservoir formation, and its efficient development is of great significance to national energy security. Compared with a conventional oil reservoir, a conglomerate reservoir in Mahu sag is higher in reservoir heterogeneity due to conglomerate, and features deep burial, poor physical properties, undeveloped natural fractures, high closure pressure, etc. Field practice shows that in-segment multi-cluster volume fracturing of a horizontal well is a key means of cost reduction and benefit increase of the conglomerate oil reservoir. By appropriately prolonging the segment length, increasing the number of in-segment clusters, and reducing the number of construction segments in a single well, the fracturing cost of the single well can be reduced by 15%-20%. However, the conglomerate reservoir has high heterogeneity with uneven distribution of conglomerate contents and sizes, great change in lithology, and complicated stress distribution. As a result, balanced fracture initiation of in-segment perforation clusters cannot be effectively achieved during the in-segment multi-cluster volume fracturing reconstruction of the horizontal well, the amounts of injected fluid and sand of the perforation clusters in the same reconstruction segment vary dramatically, some perforation clusters are reconstructed excessively due to large amounts of injected fluid and sand while some perforation clusters are not fully reconstructed due to small amounts of injected fluid and sand, and the employment degree of the reservoir is seriously influenced. In 2020, the in-segment multi-cluster fracturing technology was promoted in Mahu conglomerate reservoir, over 40% of perforation clusters did not contribute to oil and gas flow as shown in fluid yield profile tests, and merely 2-3 clusters of 6 clusters in a single segment were fractured and eroded by sand shown in a downhole Hawkeye test. The yield per single well was decreased by 40%-55% compared with that in 2019. In view of that, by combining the comprehensive data of drilling, logging and testing, the development of the geological-engineering sweet spot collaborative optimization technology, optimization of the segmentation and clustering technology, and balanced fracture initiation of the clusters are of great significance to production increase and cost reduction of the single well of the conglomerate oil reservoir.

By combining characteristics of a reservoir, two main problems need to be tackled urgently as below:

(1) Different from conventional sandstone, the correlation between a dominant fluid injected cluster and a horizontal minimum principal stress is poor, and main controlling factors of fracture initiation are unclear. Dominant fluid injected clusters in conventional sandstone reservoir are all low in stress. As shown in the downhole optical fiber monitoring, a weak correlation is discovered between dominant fluid injection channels and the minimum principal stress in the conglomerate oil reservoir, and a new engineering sweet spot identification method is urgently needed for providing a basis for the segmentation and clustering.

(2) At present, a segmentation and clustering method does not organically integrate parameters of geological engineering sweet spots, and is inapplicable to the conglomerate reservoir stratum. Conventional segmentation and clustering mainly depicts a geological sweet spot and an engineering sweet spot, and selects the “double sweet spots” as a dominant perforation cluster through comprehensive comparison. The geological sweet spot is porous, permeable, saturated and oil and gas-bearing, and the engineering sweet spot is mainly a location and stress of a collar. Relying on the stress merely, the engineering sweet spot cannot effectively depict fracture initiation characteristics of the clusters. The geological sweet spot and the engineering sweet spot are still separated, and are not combined as an unified organic whole for directing the segmentation and clustering.

### SUMMARY OF THE INVENTION

An objective of examples of the disclosure is to provide to a method for segmentation and clustering of a conglomerate reservoir, an apparatus for segmentation and clustering of a conglomerate reservoir, a machine-readable storage medium, and a processor.

In order to achieve the above objective, a first aspect of the disclosure provides a method for segmentation and clustering of a conglomerate reservoir. The method includes:
obtaining mechanical specific energy, geological parameter information, and engineering parameter information of a horizontal well;
performing, by using a clustering analysis algorithm, multidimensional data classification on depth data points of the horizontal well according to the mechanical specific energy, the geological parameter information, and the engineering parameter information of the horizontal well, and obtaining a classification result;
segmenting a depth of the horizontal well by using the classification result and a preset horizontal segment length, and obtaining a segmentation result;
computing, by using an approach degree algorithm, a comprehensive approach degree of geological engineering parameters at depths in segments in the segmentation result, and obtaining a perforation cluster position in each segment according to the comprehensive approach degree of the geological engineering parameters at the depths in the each segment; and
obtaining a segmentation and clustering result of the conglomerate reservoir according to the segmentation result and the perforation cluster position.

In the examples of the disclosure, wherein obtaining mechanical specific energy of the horizontal well comprises:
obtaining basic parameter information, wherein the basic parameter information comprises at least drilling data and drilling tool assembly parameters; and
computing the mechanical specific energy of the horizontal well by using a friction model of the horizontal well according to the basic parameter information.

In the examples of the disclosure, wherein the computing the mechanical specific energy of the horizontal well by using a friction model of the horizontal well according to the basic parameter information comprises:
plugging the basic parameter information into a modified mechanical specific energy computation formula in the friction model of the horizontal well, and obtaining the mechanical specific energy of the horizontal well; wherein
the modified mechanical specific energy computation formula is as follows:

$$E = \frac{4 P}{π {D}_{b}^{2} {e}^{{a}_{k ,} {μ}_{well}}} + \frac{240 q Δ {p}_{p} ( n + {K}_{N} Q )}{π {D}_{b}^{2} υ} + \frac{160 {μ}_{bit} {PD}_{b} ( n + {K}_{N} Q )}{{D}_{b}^{2} υ {e}^{{a}_{k} {μ}_{well}}} ,$$

wherein E denotes the mechanical specific energy of the horizontal well, P denotes a weight on bit, D_{b} denotes a diameter of a drill bit, e denotes a natural logarithm, αₖ denotes an angle of inclination, μ_{well} denotes a friction coefficient of a drill string, ν denotes a drilling speed, q denotes a displacement per revolution of a drilling tool, Δpₚ denotes a nozzle pressure drop of a screw drilling tool, n denotes a number of revolutions of a rotary table, μ_{bit} denotes a friction coefficient of the drill bit, K_{N} denotes a speed-flow ratio of a motor drilling tool, and Q denotes a total flow.

In the examples of the disclosure, wherein the performing, by using a clustering analysis algorithm, multidimensional data classification on depth data points of the horizontal well according to the mechanical specific energy, the geological parameter information, and the engineering parameter information of the horizontal well, and obtaining a classification result comprise:
S1: preprocessing the mechanical specific energy, the geological parameter information, and the engineering parameter information of the horizontal well, and obtaining preprocessed data, wherein the preprocessed data comprise a plurality of samples, and each sample comprises mechanical specific energy, geological parameter information, and engineering parameter information of the horizontal well;
S2: randomly selecting K centers from the depth data points of the horizontal well;
S3: defining a loss function;
S4: setting a number of iterations;
S5: evaluating a distance between each sample and a clustering center, and assigning each sample to a cluster to which a nearest center belongs, and recomputing a clustering center point of each category in a case that a loss condition or an iteration stop condition is not satisfied; and
S6: repeating S5 until the loss function converges, and obtaining the classification result.

In the examples of the disclosure, wherein the segmenting a depth of the horizontal well by using the classification result and a preset horizontal segment length, and obtaining a segmentation result comprises:
obtaining an initial segmentation point, segmenting the depth of the horizontal well according to the preset horizontal segment length from the initial segmentation point, and obtaining an initial segmentation result;
assigning, according to classification results of data points in segments in the initial segmentation result, an identical label to data points that have an identical classification result in the segment, wherein labels corresponding to different classification results are different;
counting numbers of data points corresponding to labels in the segments in the initial segmentation result;
taking a classification result corresponding to a label that corresponds to a maximum number of data points as a majority point characteristic value within a segment length range of the each segment; and
obtaining the segmentation result according to majority point characteristic values within the segment length range of the segments.

In the examples of the disclosure, wherein the obtaining the segmentation result according to majority point characteristic values within the segment length range of the segments comprises:
determining whether the majority point characteristic values within the segment length range of the segments fall into one category in the classification results; if so, taking the initial segmentation result as the segmentation result; and if not, adjusting the preset horizontal segment length or/and adjusting the initial segmentation point, performing resegmenting, and obtaining the segmentation result.

In the examples of the disclosure, wherein the computing, by using an approach degree algorithm, a comprehensive approach degree of geological engineering parameters at depths in segments in the segmentation result, and obtaining a perforation cluster position in each segment according to the comprehensive approach degree of the geological engineering parameters at the depths in the each segment comprise:
establishing a fuzzy matter-element according to mechanical specific energy, geological parameter information, and engineering parameter information of the horizontal well of the segments;
computing, based on a fuzzy variable value in the fuzzy matter-element, preferred membership degrees of fuzzy variable values of evaluation indexes according to a preferred membership degree principle;
establishing a difference square compound fuzzy matter-element according to the preferred membership degrees of the fuzzy variable values of the evaluation indexes;
determining weights of characteristics;
plugging the difference square compound fuzzy matter-element and the weights of the characteristics into an approach degree computation formula, and obtaining the comprehensive approach degree of the geological engineering parameters at the depths in the segments; and obtaining the perforation cluster position in each segment according to the comprehensive approach degree of the geological engineering parameters at the depths in the each segment.

A second aspect of the disclosure provides an apparatus for segmentation and clustering of a conglomerate reservoir. The apparatus for segmentation and clustering of a conglomerate reservoir includes:
an information obtainment module, configured to obtain mechanical specific energy, geological parameter information, and engineering parameter information of a horizontal well;
a classification module, configured to perform, by using a clustering analysis algorithm, multidimensional data classification on depth data points of the horizontal well according to the mechanical specific energy, the geological parameter information, and the engineering parameter information of the horizontal well, and obtain a classification result;
a segmentation module, configured to segment a depth of the horizontal well by using the classification result and a preset horizontal segment length, and obtain a segmentation result;
a clustering module, configured to compute, by using an approach degree algorithm, a comprehensive approach degree of geological engineering parameters at depths in segments in the segmentation result, and obtain a perforation cluster position in each segment according to the comprehensive approach degree of the geological engineering parameters at the depths in the each segment; and
a result output module, configured to obtain a segmentation and clustering result of the conglomerate reservoir according to the segmentation result and the perforation cluster position.

A third aspect of the disclosure provides a processor. The processor is configured to execute the method for segmentation and clustering of a conglomerate reservoir described above.

A fourth aspect of the disclosure provides a machine-readable storage medium. The machine-readable storage medium stores instructions, where the instructions cause a processor to be configured to execute the method for segmentation and clustering of a conglomerate reservoir described above when executed by the processor.

According to the technical solution, accuracy of identifying an engineering sweet spot of the sandy conglomerate reservoir can be greatly improved through the horizontal well mechanical specific energy. The clustering analysis algorithm is used for classification and segmentation, such that similarity of geological engineering parameters in the segment of the horizontal well can be ensured. In addition, the approach degree is computed by the approach degree algorithm, the perforation cluster position is obtained, and the method for segmentation and clustering of a sandy conglomerate based on collaborative optimization of geological engineering sweet spots is formed for directing volume fracturing in-segment multi-cluster balanced transformation of the horizontal well of the conglomerate oil reservoir. Thus, balance of geological engineering parameter distributions at a perforation point in the segment is effectively improved, balanced fracture initiation of the clusters in an in-segment multi-cluster fracturing process is implemented advantageously, construction difficulty is reduced, probability of occurrence of complex working conditions during construction is reduced, a construction fluid amount is reduced, an investment is reduced, and oil and gas well production is increased. This method is convenient in computation and simple in operation.

Other features and advantages of the examples of the disclosure will be described in detail in the following specific embodiments.

### BRIEF DESCRIPTION OF DRAWINGS

The accompanying drawings are used for providing further understanding of the examples of the disclosure as a constituent part of the description, serve to explain the examples of the disclosure together with following specific embodiments, but do not constitute limitation to the examples of the disclosure. In the figures:

FIG. 1 illustratively shows a schematic diagram of an application environment of a method for segmentation and clustering of a conglomerate reservoir according to an example of the disclosure;

FIG. 2 illustratively shows a schematic flowchart of a method for segmentation and clustering of a conglomerate reservoir according to an example of the disclosure;

FIG. 3 illustratively shows a schematic flowchart of an embodiment of a method for segmentation and clustering of a conglomerate reservoir according to an example of the disclosure;

FIG. 4 illustratively shows a statistical diagram of a relation between a dominant fluid injection channel and mechanical specific energy during optical fiber monitoring according to an example of the disclosure;

FIG. 5 illustratively shows a schematic diagram of a clustering principle of an approach degree method according to an example of the disclosure;

FIG. 6 illustratively shows a distribution diagram of geological engineering parameters at a perforation according to an example of the disclosure;

FIG. 7 illustratively shows a construction curve diagram according to an example of the disclosure;

FIG. 8 illustratively shows a statistical diagram of construction results according to an example of the disclosure;

FIG. 9 illustratively shows a distribution diagram of mechanical specific energy according to an example of the disclosure;

FIG. 10 illustratively shows a result diagram of clustering analysis according to an example of the disclosure;

FIG. 11 illustratively shows a computation result diagram of an approach degree at a depth near a first cluster position in a single segment according to an example of the disclosure;

FIG. 12 illustratively shows a result diagram of segmentation and clustering optimization according to an example of the disclosure;

FIG. 13 illustratively shows a structural block diagram of an apparatus for segmentation and clustering of a conglomerate reservoir according to an example of the disclosure; and

FIG. 14 illustratively shows an internal structural diagram of a computer device according to an example of the disclosure.

### DESCRIPTION OF REFERENCE NUMERALS

102—terminal; 104—server; 410—information obtainment module; 420—classification module; 430—segmentation module; 440—clustering module; 450—result output module; A01—processor; A02—network interface; A03—internal memory; A04—display screen; A05—input apparatus; A06—nonvolatile storage medium; B01—operation system; and B02—computer program.

### DETAILED DESCRIPTION OF THE EMBODIMENTS

To make the objectives, technical solutions, and advantages of the examples of the disclosure clearer, the technical solutions in the examples of the disclosure will be clearly and completely described with reference to the accompanying drawings in the examples of the disclosure. It should be understood that the specific embodiments described herein are merely used to describe and explain the examples of the disclosure rather than limit the examples of the disclosure. All other examples derived by a person of ordinary skill in the art from the examples of the disclosure without creative efforts should fall within the protection scope of the disclosure.

It is to be noted that if directional indications (for example, up, down, left, right, front and rear . . . ) are included in the examples of the disclosure, the directional indications are merely used to explain relative positional relations, motion conditions, etc. between components in a certain specific posture (as shown in the accompanying drawings), and if the specific posture changes, the directional indications also change accordingly.

In addition, if there is description involving “first”, “second”, etc., in the example of the disclosure, the description of “first”, “second”, etc. are merely used for describing purposes and cannot be understood as indicating or implying relative importance, or implicitly indicating the number of indicated technical features. Thus, the features defined with “first” and “second” can explicitly or implicitly include at least one of the features. In addition, technical solutions of the examples can be combined with each other on the premise that such a combination can be implemented by a person of ordinary skill in the art, and when the combination of technical solutions is contradictory or impossible to implement, it should be considered that such a combination of the technical solutions does not exist and should fall beyond the protection scope required by the disclosure.

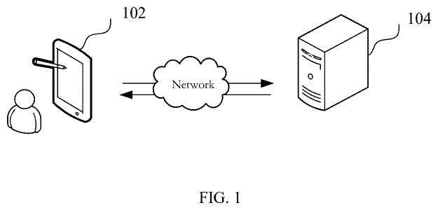

A method for segmentation and clustering of a conglomerate reservoir according to the disclosure may be applied to an application environment shown in FIG. 1. A terminal 102 communicates, through a network, with a server 104 through the network. The server 104 obtains mechanical specific energy, geological parameter information, and engineering parameter information of a horizontal well from the terminal 102. Then, the server performs, by using a clustering analysis algorithm, multidimensional data classification on depth data points of the horizontal well according to the mechanical specific energy, the geological parameter information, and the engineering parameter information of the horizontal well, and obtains a classification result. Then, the server segments a depth of the horizontal well by using the classification result and a preset horizontal segment length, and obtains a segmentation result. The server computes, by using an approach degree algorithm, a comprehensive approach degree of geological engineering parameters at depths in segments in the segmentation result, and obtains a perforation cluster position in each segment according to the comprehensive approach degree of the geological engineering parameters at the depths in the each segment. The server obtains a segmentation and clustering result of the conglomerate reservoir according to the segmentation result and the perforation cluster position. The terminal 102 may include, but is not limited to, various personal computers, notebook computers, smart phones, portable android devices, and portable wearable devices. The server 104 may be implemented by an independent server or the server cluster composed of a plurality of servers.

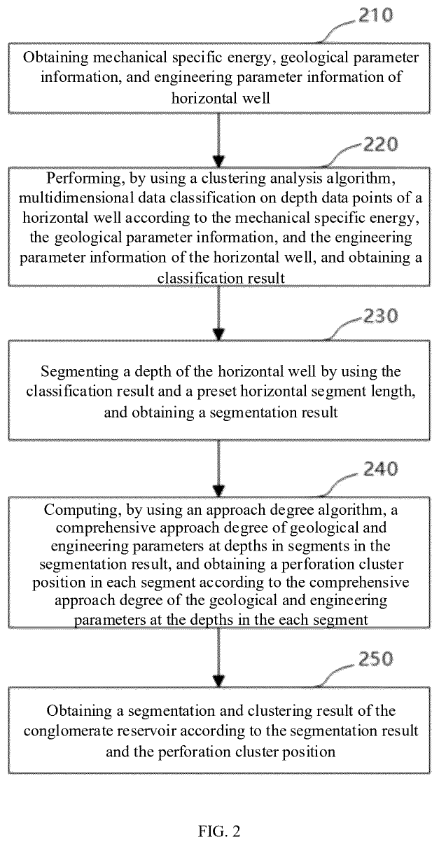

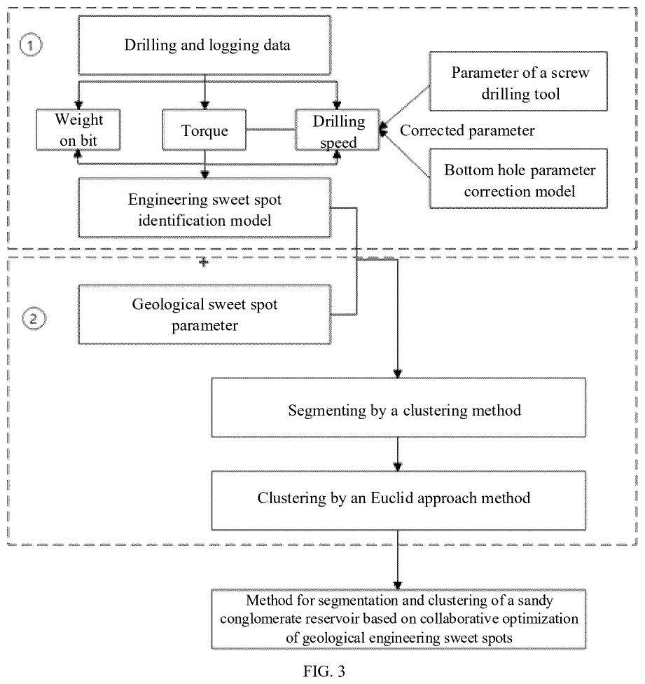

FIG. 2 illustratively shows a schematic flowchart of a method for segmentation and clustering of a conglomerate reservoir according to an example of the disclosure. FIG. 3 illustratively shows a schematic flowchart of an embodiment of a method for segmentation and clustering of a conglomerate reservoir according to an example of the disclosure. As shown in FIG. 1, in an example of the disclosure, the method for segmentation and clustering of a conglomerate reservoir is provided. This example is mainly described with this method applied to the terminal 102 (or the server 104) in the FIG. 1. The method includes Steps 210-250.

Step 210: obtaining mechanical specific energy, geological parameter information, and engineering parameter information of a horizontal well. The geological parameter information of the horizontal well includes logging data, conglomerate linear density, an oil-bearing index, etc., which may be obtained according to actual working conditions of a horizontal well. The engineering parameter information of the horizontal well includes a position and stress of a horizontal well collar, which may be obtained according to actual working conditions of the horizontal well. The mechanical specific energy of the horizontal well may be computed according to a mechanical specific energy model, or may be obtained by correcting the mechanical specific energy according to the actual conditions. The mechanical specific energy represents mechanical energy expended to drill through unit volume of rock, and the mechanical specific energy integrates characteristics of rock mechanics and rock compressibility, and may be used to identify an engineering sweet spot, making identification accuracy of the engineering sweet spot higher. By obtaining the mechanical specific energy of the horizontal well, the geological parameter information of the horizontal well, and the engineering parameter information of the horizontal well, information of the horizontal well can be obtained from both geological engineering aspects, and later segmentation and clustering computation is implemented advantageously.

Since a screw drilling tool is usually used to accelerate a drilling speed in a process of drilling the horizontal segment, it is necessary to consider influence of friction during drilling of the horizontal well and parameters of the screw drilling tool on the mechanical specific energy. The mechanical specific energy of the horizontal well may be obtained through correction as follows:

At first, basic parameter information is obtained. The basic parameter information includes at least drilling data and drilling tool assembly parameters. The drilling data include a weight on bit, torque, a drilling speed, etc., and the drilling tool assembly parameters include screw drilling tool parameters. The basic parameter information may be obtained according to the actual working conditions.

Then, the mechanical specific energy of the horizontal well is computed by using a friction model of the horizontal well according to the basic parameter information. The friction model of the horizontal well is a mechanical specific energy correction model of the horizontal well established by considering the influence of the friction during the horizontal well drilling and the screw drilling tool parameters on the mechanical specific energy. The friction model of the horizontal well may correct the mechanical specific energy.

The mechanical specific energy of the horizontal well computed described above may be the mechanical specific energy of the horizontal well obtained by plugging the basic parameter information into the friction model of the horizontal well. A modified mechanical specific energy computation formula is as follows:

$$E = \frac{4 P}{π {D}_{b}^{2} {e}^{{a}_{k ,} {μ}_{well}}} + \frac{240 q Δ {p}_{p} ( n + {K}_{N} Q )}{π {D}_{b}^{2} υ} + \frac{160 {μ}_{bit} {PD}_{b} ( n + {K}_{N} Q )}{{D}_{b}^{2} υ {e}^{{a}_{k} {μ}_{well}}} ,$$

in the formula, E denotes the mechanical specific energy of the horizontal well in unit of MPa, P denotes a weight on bit in unit of MPa, D_{b} denotes a diameter of a drill bit in unit of mm, e denotes a natural logarithm, αₖ denotes an angle of inclination in unit of rad, μ_{well} denotes a friction coefficient of a drill string, ν denotes a drilling speed in unit of m/h, q denotes a displacement per revolution of a drilling tool, which is a structure parameter, merely related to linear types and geometric dimensions of a stator and a rotor in unit of L/r, Δpₚ denotes a nozzle pressure drop of a screw drilling tool, in unit of MPa, n denotes a number of revolutions of a rotary table in unit of r/min, μ_{bit} denotes a friction coefficient of the drill bit, K_{N} denotes a speed-flow ratio of a motor drilling tool in unit of r/L, and Q denotes a total flow in unit of L/s.

In some examples, in order to advantageously implement computation with the modified mechanical specific energy computation formula, the friction model of the horizontal well may alternatively correct the drilling data at first, and then plug corrected drilling data and drilling tool assembly parameters into the modified mechanical specific energy computation formula, to obtain the mechanical specific energy of the horizontal well.

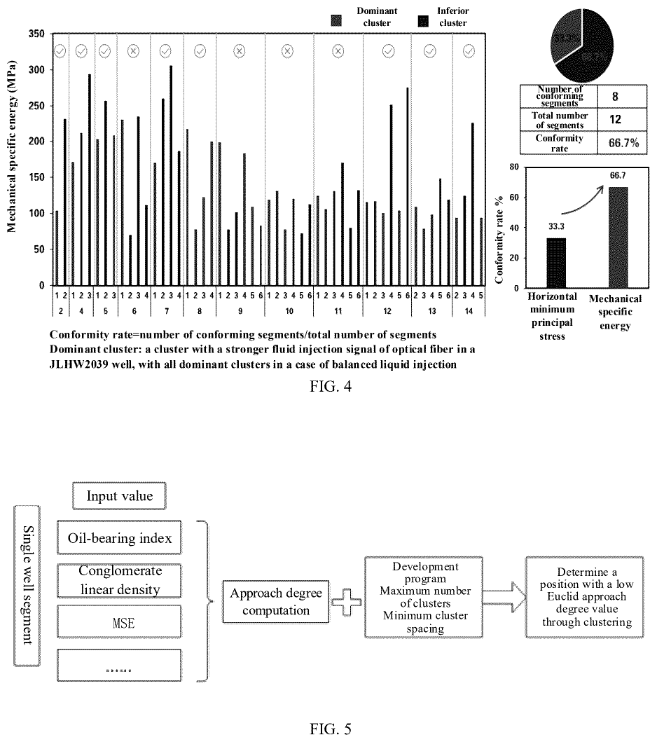

With reference to FIG. 4, FIG. 4 illustratively shows a statistical diagram of a relation between a dominant fluid injection channel and mechanical specific energy during optical fiber monitoring according to an example of the disclosure. By obtaining the mechanical specific energy of the horizontal well and with the method for identifying the engineering sweet spot through the mechanical specific energy, the identification accuracy of the engineering sweet spots can be improved.

Step 220: performing multidimensional data classification by using a clustering analysis algorithm on depth data points of a horizontal well according to the mechanical specific energy, the geological parameter information, and the engineering parameter information of the horizontal well, and obtaining a classification result. In this example, the horizontal well geological parameter information may be one or more of the logging data, the conglomerate linear density, the oil-bearing index, etc., and the engineering parameter information may be one or more of the position, the stress, etc. of a horizontal well collar, and may be set according to actual needs. The horizontal well may be composed of a plurality of data points in depth, for example, a point at a depth of 100 meters and a point at a depth of 300 meters. The data points may be described in a plurality of dimensions, for example, each data point has corresponding mechanical specific energy, logging data, and conglomerate linear densities.

It should be noted that the multidimensional data classification may be data classification using a corresponding number of dimensions according to a data number of the mechanical specific energy, the geological parameter information, and the engineering parameter information of the horizontal well. For example, according to the mechanical specific energy, the logging data and the conglomerate linear density, the clustering analysis algorithm is used for three dimensional data classification on the data points in depth of the horizontal well. According to the mechanical specific energy and the oil-bearing index, the clustering analysis algorithm is used for two dimensional data classification on the data points in depth of the horizontal well.

The clustering analysis algorithm is used for the multidimensional data classification on the data points in depth of the horizontal well, indicating that the data are classified through analysis in a plurality of dimensions. The clustering analysis algorithm may be obtained by importing the mechanical specific energy, the geological parameter information, and the engineering parameter information of the horizontal well into the clustering analysis model. The clustering analysis algorithm may be a kmeans algorithm, and the kmeans algorithm is a typical distance-based clustering algorithm, and takes the distance as an evaluation index of similarity, that is, the closer the distance between two objects is, the greater similarity is. The core of the kmeans algorithm is to divide a given data set into K categories according to a number of clusters, and then whether a clustering result satisfies a loop stop condition is determined through loop iteration. Specifically, steps are included as follows:

S1: the mechanical specific energy, the geological parameter information, and the engineering parameter information of the horizontal well are preprocessed, and preprocessed data are obtained. The preprocessed data include a plurality of samples, and each sample includes the mechanical specific energy, the parameter information, and the engineering parameter information of the horizontal well. The preprocessing includes data standardization, abnormal point filtering, etc., for the convenience of later classification.

S2: K centers are randomly selected from the depth data points of the horizontal well. For example, the k centers are expressed as:

$${u}_{1}^{( 0 )} , {u}_{2}^{( 0 )} , {u}_{3}^{( 0 )} , … , {u}_{k}^{( 0 )} .$$

S3: a loss function is defined. In a multidimensional space composed of all geological engineering parameters, the loss function corresponding to the clustering result of the geological engineering parameters is minimized by iteratively finding K clusters. The loss function describes a closeness degree between clustering center points, and the smaller the value of the loss function is, the higher the similarity between samples in the cluster is, the better a clustering effect is. In general, the loss function is defined as:

$$J ( c , u ) = {\sum }_{i = 1}^{M} {‖ {x}_{i} - {u}_{{c}_{1}} ‖}^{2} .$$

In the formula, J(c,u) denotes an error sum of squares of samples from a central point of a cluster to which the samples belong, xᵢ denote an i^{th} sample, cᵢ denotes a cluster to which xᵢ belongs, u_{c}_{ᵢ} denotes the central point corresponding to the cluster, and M denotes a total number of samples.

S4: a number of iterations is set as t, and may be set according to actual conditions.

S5: distances between each sample and the clustering center are evaluated, and each sample is assigned to a cluster to which a nearest center belongs. A clustering center point of each category is recomputed if a loss condition or an iteration stop condition is not satisfied. The following formula may be used to evaluate the distances from each sample to the clustering center and assign each sample xᵢ to the cluster to which the nearest center belongs:

$${C}_{i}^{t} < - arg {min}_{k} {‖ {x}_{i} - {u}_{{c}_{1}} ‖}^{2} .$$

In the formula, xᵢ denotes the center point of each category, and

$${C}_{i}^{t}$$

denotes the distance from each sample to the clustering center. If the loss condition or the iteration stop condition is not satisfied, the center point k of each category is recomputed by the following formula:

$${u}_{k}^{( t + 1 )} < - arg {min}_{n} {\sum }_{i : {c}_{i}^{t} = 1}^{k} {‖ {x}_{i} - {u}_{{c}_{i}} ‖}^{2} .$$

In the formula,

$${u}_{k}^{( t + 1 )}$$

denotes a center of mass position after t+1 iterations.

S6: S5 is repeated until the loss function converges, and the classification result is obtained.

The kmeans algorithm is very fast and can quickly classify the data points in depth of the horizontal well.

Step 230: segmenting a depth of the horizontal well by using the classification result and a preset horizontal segment length, and obtaining a segmentation result. The segmentation is to divide the depth of the horizontal well into a plurality of segments, and specifically includes the following steps.

At first, an initial segmentation point is obtained, the depth of the horizontal well is segmented according to the preset horizontal stage length from the initial segmentation point, and an initial segmentation result is obtained. The initial segmentation point refers to a point where the segmentation begins, may be selected according to experience or actual condition, and generally starts from a point A, that is, a bottom of the horizontal well. The preset horizontal segment length may be a segment length range determined by combining previous development experience, and then a maximum horizontal segment length may be selected according to the set segment length range. For example, the segment length range is 50-100, and the horizontal segment length may be set as 100.

Then, an identical label is assigned to data points that have an identical classification result in the segment according to classification results of data points in segments in the initial segmentation result. Labels corresponding to different classification results are different. In this example, each segment in the initial segmentation result includes a plurality of data points, each data point has a classification result in the step 220, then one label may be assigned to each classification result, and different labels may be assigned to different categories. For example, a label K1 is assigned to a point with a category N1, and a label K2 is assigned to a point with a category N2.

Then, numbers of data points corresponding to labels in the segments in the initial segmentation result are counted. A plurality of categories may occur in each segment, each category includes a plurality of data points, and the numbers of data points corresponding to the labels may be counted separately.

Then, a classification result corresponding to a label that corresponds to a maximum number of data points is taken as a majority point characteristic value within a segment length range of the each segment. The classification results corresponding to the labels are taken as the characteristic value in this segment. For example, in the example, the characteristic values in the segment include K1 and K2. Then, a label that corresponds to a maximum number of data points is taken as a majority point characteristic value within a segment length range of the each segment. For example, in the above example, there are five data points corresponding to K1 and two data points corresponding to K2, such that the majority point characteristic value within the segment length range of the segment is K1.

Finally, the segmentation result is obtained according to majority point characteristic values within the segment length range of the segments. Since data points may be evenly distributed in the segmentation process, no majority point characteristic values exist, indicating that the segmentation is invalid. That is, if the majority point characteristic value belongs to one of the classification results, the segmentation is effective, otherwise, adjustment is required, which may be determined as follows:

whether the majority point characteristic values within the segment length range of the segments fall into one category in the classification results is determined; if so, the initial segmentation result is taken as the segmentation result; and if not, the preset horizontal segment length is adjusted or/and the initial segmentation point is adjusted, resegmenting is performed, and the segmentation result is obtained.

It should be noted that the re-segmenting may be to adjust the preset horizontal segment length, for example, reduce the horizontal segment length until the horizontal segment length is reduced to a minimum value as redetermined. The resegmenting may alternatively adjust the initial segmentation point, for example, move the initial staging point backwards by 1 m. The restaging may alternatively adjust the preset horizontal segment length at first, and then adjust the initial segmentation point.

For example, whether the majority point characteristic value within the segment length range belongs to a category in the clustering analysis results is determined from a point A. If so, the segment range may be classified as one category; if not, the segment length range may be reduced and determined again until the length is reduced to the minimum value. If the segmentation is still impossible, the starting point will be moved backwards by 1 m, and the determination process will be repeated until an overall horizontal segment is segmented.

Step 240: computing a comprehensive approach degree of geological engineering parameters at depths in segments in the segmentation result by using an approach degree algorithm, and obtaining a perforation cluster position in each segment according to the comprehensive approach degree of the geological engineering parameters at the depths in the each segment. With reference to FIG. 5, FIG. 5 illustratively shows a schematic diagram of a clustering principle of an approach degree method according to an example of the disclosure. Specifically, steps are included as follows:

At first, a fuzzy matter-element is established according to mechanical specific energy, geological parameter information, and engineering parameter information of the horizontal well of the segments. For a given matter, a triplet (a matter M, a characteristic C, and a variable value x) may be used to represent basic elements of the matter. If the variable value of the matter is fuzzy, the matter may be referred to as a fuzzy matter-element, and expressed as

$$R = ( \begin{matrix} & M \\ C & x\end{matrix} ) :$$

If the matter

M has n characteristics C1, C2, . . . ,Cn, and fuzzy variable values x1, x2 . . . , xn corresponding to these characteristics, Rₙ is referred to as an n-dimensional fuzzy matter-element. If there are m matters described by common n characteristics C1, C2, . . . , Cn and corresponding fuzzy variable values x1, x2, . . . , xn, then Rₙₘ is referred to as an n-dimensional fuzzy complex element of m objects, and is expressed as:

$${R}_{nm} = [ \begin{matrix} & {M}_{1} & ⋯ & {M}_{m} \\ {C}_{1} & {x}_{11} & ⋯ & {x}_{1 m} \\ {C}_{2} & {x}_{21} & ⋯ & {x}_{2 m} \\ ⋮ & ⋮ & & ⋮ \\ {C}_{n} & {x}_{n 1} & ⋯ & {x}_{nm}\end{matrix} ] .$$

Then, preferred membership degrees of fuzzy variable values of evaluation indexes are computed based on a fuzzy variable value in the fuzzy matter-element according to a preferred membership degree principle. According to the effect of the index, the preferred membership degree may be divided into two types:

In a first type, the larger the oil-bearing index is, the more preferred the index is, and the preferred membership degree is expressed by a formula as follows:

$${u}_{ij} = \frac{{x}_{ij}}{max {x}_{ij}} .$$

In a second type, the smaller the mechanical specific energy and the conglomerate linear density are, the more preferred the indexes are, and the preferred membership degree is expressed by a formula as follows:

$${u}_{ij} = \frac{{min}_{ij}}{{x}_{ij}} .$$

In the formula, min xᵢⱼ and max xᵢⱼ denote a minimum value and a maximum value of an ith index in the matters respectively, that is, the minimum value and the maximum value of each row in Rₙₘ According to the fuzzy matter-element formula, the preferred membership degree fuzzy matter-element

$${R}_{n m}^{′}$$

may be obtained by computation as follows:

$${R}_{nm}^{′} = [ \begin{matrix} & {M}_{1} & ⋯ & {M}_{m} \\ {C}_{1} & {u}_{11} & ⋯ & {u}_{1 m} \\ {C}_{2} & {u}_{21} & ⋯ & {u}_{2 m} \\ ⋮ & ⋮ & & ⋮ \\ {C}_{n} & {u}_{n 1} & ⋯ & {u}_{nm}\end{matrix} ] .$$

Then, a difference square compound fuzzy matter-element is established according to the preferred membership degrees of the fuzzy variable values of the evaluation indexes. Before the difference square compound fuzzy matter-element is established, it is necessary to determine a standard (optimal) fuzzy matter-element. The standard fuzzy matter-element is the maximum value or the minimum value of the preferred membership degree of each index in the preferred membership degree fuzzy matter-elements

$${R}_{n m}^{′} ,$$

and is expressed as Rₒ. After the standard fuzzy matter-element is established, a square of a difference between the items of each index in the preferred membership degree fuzzy matter-element

$${R}_{n m}^{′}$$

and the standard fuzzy matter-element Rₒ is expressed as:
Vᵢⱼ(i=1, 2, . . . , n; j=1, 2, . . . , m), that is Vᵢⱼ=(uᵢⱼ−uₒⱼ)², the difference square compound fuzzy matter-element Rᵥ may be established, and expressed as:

$${R}_{v} = [ \begin{matrix} & {M}_{1} & ⋯ & {M}_{m} \\ {C}_{1} & {v}_{11} & ⋯ & {v}_{1 m} \\ {C}_{2} & {v}_{21} & ⋯ & {v}_{2 m} \\ ⋮ & ⋮ & & ⋮ \\ {C}_{n} & {v}_{n 1} & ⋯ & {v}_{nm}\end{matrix} ] .$$

Then, weights of characteristics are determined. Unbalanced development of clusters in the segment is mainly caused by a case that a difference in fracture initiation conditions of the clusters is excessive, and a pressure in the segment cannot satisfy fracture initiation requirements of other clusters after fracture initiation of a dominant cluster caused by the excessive difference. Thus, fundamental demand for the balanced development of the clusters in the segment lies in guarantee of similarity among characteristics of the perforation clusters. In order to satisfy this demand, a variance is used by the model as the weight of the characteristics, and may be expressed as follows:

$${w}_{j} = \sqrt{\frac{{\sum }_{i = 1}^{n} {( {x}_{i} - μ )}^{2}}{n}} ,$$

in the formula, wⱼ denotes a variance weight of a characteristic value Cⱼ, μ denotes an average of the characteristic value Cⱼ, n denotes a number of characteristic values Cⱼ and xᵢ denotes a magnitude of the characteristic value Cⱼ.

Then, the difference square compound fuzzy matter-element and the weights of the characteristics are plugged into an approach degree computation formula, and the comprehensive approach degree of the geological engineering parameters at the depths in the segments is obtained. The approach degree computation formula is expressed as:

$${ρ}_{i} = \sqrt{{\sum }_{j = 1}^{n} {ω}_{j} {Δ}_{ij}} ( i = 1 , 2 … , m ; j = 1 , 2 … , n ) .$$

In the formula, ωⱼ denotes weights of the characteristics, and Δᵢⱼ denotes the difference square compound fuzzy matter-element.

Finally, the perforation cluster position in each segment is obtained according to the comprehensive approach degree of the geological engineering parameters at the depths in the each segment. In this example, after the approach degree of the geological engineering parameter is computed, a position with a minimum approach degree value is selected as the perforation cluster position.

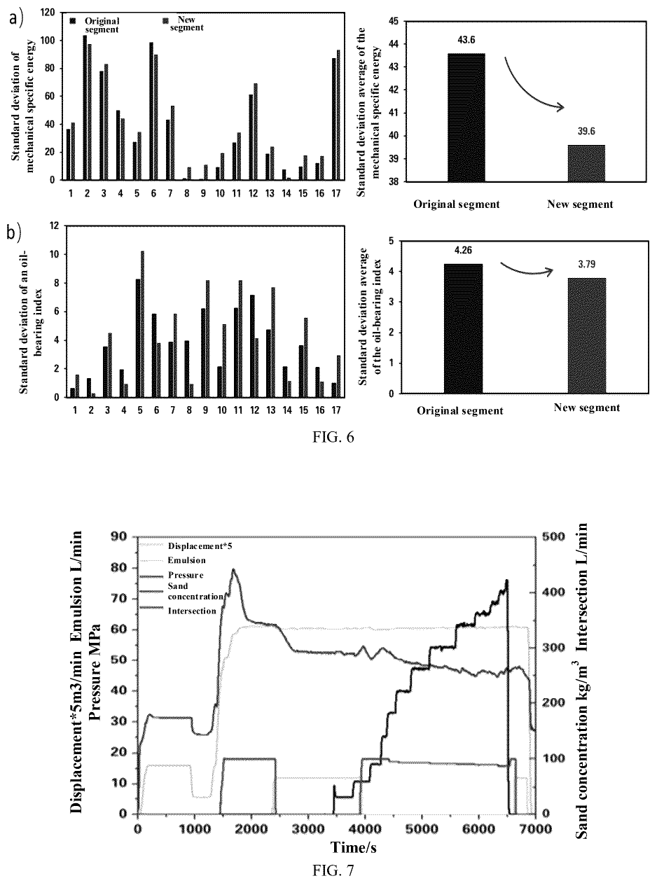

Step 250: obtaining a segmentation and clustering result of the conglomerate reservoir according to the segmentation result and the perforation cluster position. After the segmentation result is computed and obtained and the perforation cluster position is determined, the segmentation and clustering result of the conglomerate reservoir can be obtained. With reference to FIGS. 6-8, after the disclosure is used for the segmentation and clustering, the distribution of the engineering parameters is more balanced, the construction difficulty is lower, the probability of occurrence of complex working conditions during construction is reduced, and a construction fluid amount is reduced.

With a well J-1 as an example, a segmentation and clustering process will be described.

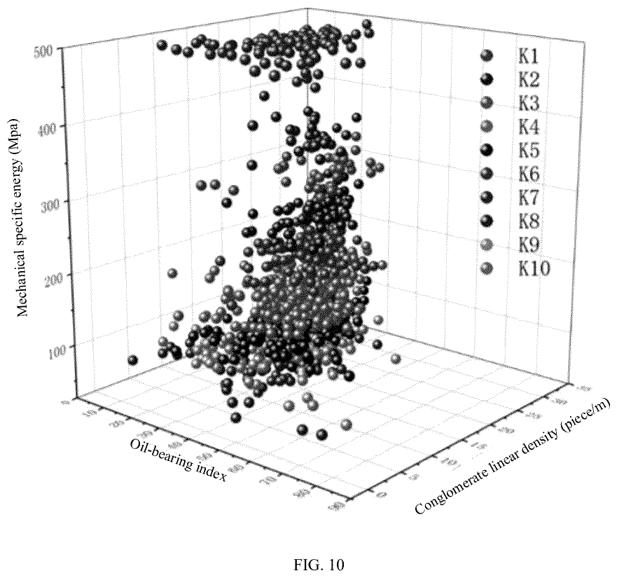

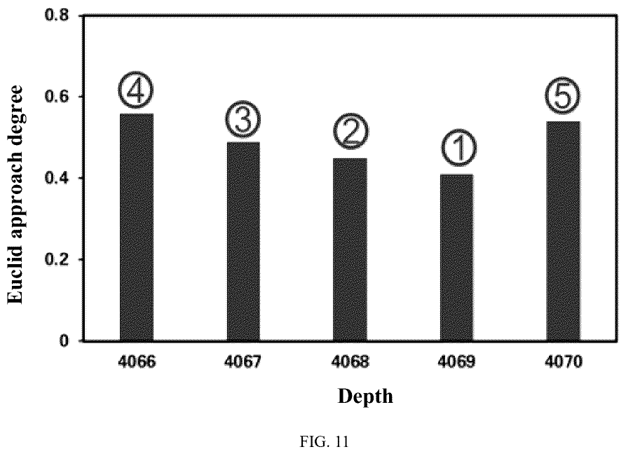

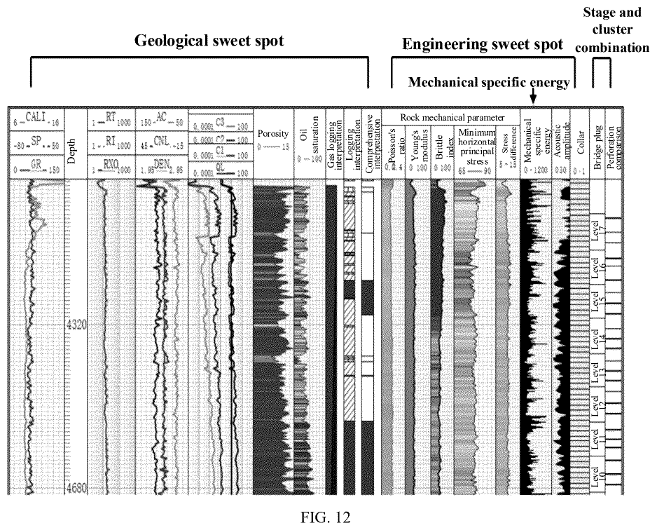

At first, a corrected drilling parameter of the well J-1 is plugged into a corrected mechanical specific energy computation formula, to compute the mechanical specific energy distribution in the horizontal segment. With reference to FIG. 9, FIG. 9 illustratively shows a distribution diagram of mechanical specific energy according to an example of the disclosure. Then, parameters of mechanical specific energy, the oil-bearing index, the conglomerate linear density are combined, and depth points of the well J-1 are classified by using the clustering analysis algorithm. Characteristic values of the segment of the horizontal well may be divided into five categories, K1-K5. With reference to FIG. 10, FIG. 10 illustratively shows a result diagram of clustering analysis according to an example of the disclosure. Then, by using the above classification result, and by combining the previous development experience, a result segment length range is limited to 50 m-100 m, and the horizontal well is segmented to obtain the segmentation result. Then, according to the segments obtained, the comprehensive approach degree of the parameters of the mechanical specific energy, the oil-bearing index, and the conglomerate linear density at each depth in the segments is computed, a clustering result is limited to 2 clusters in a first segment and 3 clusters in the remaining segments in combination with the previous development experience, and a minimum cluster spacing is 10 m. The position with a low approach degree value, that is, a depth \textcircled{1} in FIG. 11 is selected as a first cluster perforation cluster position in this segment. Finally, the segmentation and clustering result is output. With reference to FIG. 12, FIG. 12 illustratively shows a result diagram of segmentation and clustering optimization according to an example of the disclosure.

In the implementation process, the mechanical specific energy, the geological parameter information, and the engineering parameter of the horizontal well are obtained. The multidimensional data classification is performed by using the clustering analysis algorithm on the depth data points of the horizontal well according to the mechanical specific energy, the geological parameter information, and the engineering parameter information of the horizontal well, and the classification result is obtained. Then, the depth of the horizontal well is segmented by using the classification result and the preset horizontal segment length, and the segmentation result is obtained. Then, the comprehensive approach degree of the geological engineering parameters at the depths in the segments in the segmentation result is computed by using the approach degree algorithm, and the perforation cluster position in each segment is obtained according to the comprehensive approach degree of the geological engineering parameters at the depths in the each segment. Finally, the segmentation and clustering result of the conglomerate reservoir is obtained according to the segmentation result and the perforation cluster position. The accuracy of identifying the engineering sweet spot of the sandy conglomerate reservoir can be greatly improved through the mechanical specific energy. The clustering analysis algorithm is used for classification and segmentation, such that similarity of geological engineering parameters in the segment of the horizontal well can be ensured. In addition, the approach degree is computed by the approach degree algorithm, the perforation cluster position is obtained, and the method for segmentation and clustering of a sandy conglomerate based on collaborative optimization of geological engineering sweet spots is formed for directing volume fracturing in-segment multi-cluster balanced transformation of the horizontal well of the conglomerate oil reservoir. Thus, balance of geological engineering parameter distributions at a perforation point in the segment is effectively improved, balanced fracture initiation of the clusters in an in-segment multi-cluster fracturing process is implemented advantageously, the construction difficulty is reduced, the probability of occurrence of complex working conditions during construction is reduced, the construction fluid amount is reduced, the investment is reduced, and oil and gas well production is increased. This method is convenient in computation and simple in operation.

FIG. 2 is a schematic flowchart of a method for segmentation and clustering of a conglomerate reservoir according to an example. It should be understood that although steps in the flowchart of FIG. 2 are shown in sequence as indicated by arrows, these steps are not necessarily executed in sequence as indicated by the arrows. Unless explicitly stated in this text, execution of these steps is not strictly limited in sequence, and these steps can be executed in another sequence. In addition, at least some steps in FIG. 2 may include a plurality of sub-steps or a plurality of stages. These sub-steps or stages are not necessarily executed at the same moment, and may alternatively be executed at different moments. An execution sequence of these sub-steps or stages is not necessarily sequential, and these sub-steps or stages may be executed by turns or alternately with the other steps or at least some sub-steps or stages of the other steps.

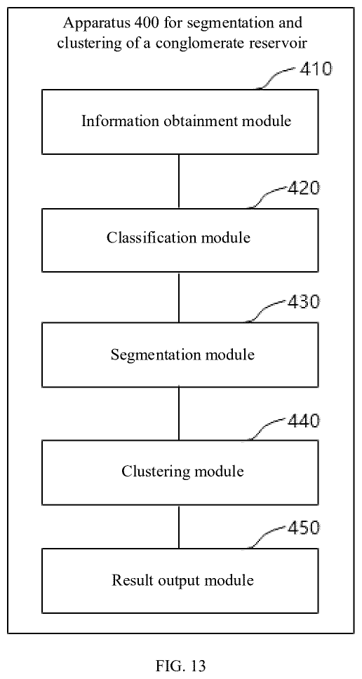

In an example, as shown in FIG. 13, FIG. 13 illustratively shows a structural block diagram of an apparatus for segmentation and clustering of a conglomerate reservoir according to an example of the disclosure. An apparatus for segmentation and clustering of a conglomerate reservoir is provided. The apparatus includes an information obtainment module 410, a classification module 420, a segmentation module 430, a clustering module 440, and a result output module 450.

The information obtainment module 410 is used to obtain mechanical specific energy, geological parameter information, and engineering parameter information of the horizontal well.

The classification module 420 is used to perform, by using a clustering analysis algorithm, multidimensional data classification on depth data points of a horizontal well according to the mechanical specific energy, the geological parameter information, and the engineering parameter information, and obtain a classification result.

The segmentation module 430 is used to segment a depth of the horizontal well by using the classification result and a preset horizontal segment length and obtain a segmentation result.

The clustering module 440 is used to compute, by using an approach degree algorithm, a comprehensive approach degree of geological engineering parameters at depths in segments in the segmentation result, and obtain a perforation cluster position in each segment according to the comprehensive approach degree of the geological engineering parameters at the depths in the each segment.

The result output module 450 is used to obtain a segmentation and clustering result of the conglomerate reservoir according to the segmentation result and the perforation cluster position. The apparatus for segmentation and clustering of a conglomerate reservoir includes a processor and a memory. The information obtainment module 410, the classification module 420, the segmentation module 430, the clustering module 440, and the result output module 450 are all stored in the memory as program units, and the processor executes the program modules stored in the memory to implement corresponding functions.

The processor contains a core, and the core invokes a corresponding program unit in the memory. One or more cores may be set, and the method for segmentation and clustering of a conglomerate reservoir may be implemented by adjusting parameters of the cores.

The memory may include a non-permanent memory, a random access memory (RAM) and/or a nonvolatile memory such as a read-only memory (ROM) or a flash RAM in the computer-readable medium, and the memory includes at least one storage chip.

The example of the disclosure provides a storage medium. The storage medium stores a program, and the program implements the method for segmentation and clustering of a conglomerate reservoir when executed by a processor.

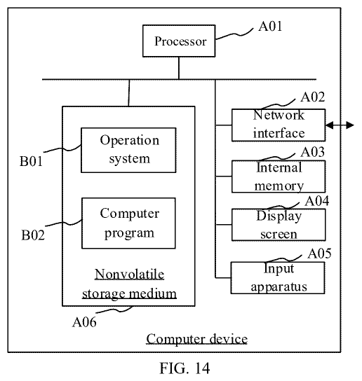

In an example, a computer device is provided. The computer device may be a terminal, and its internal structure diagram may be shown in FIG. 14. The computer device includes a processor A01, a network interface A02, a display screen A04, an input apparatus A05 and a memory (not shown in the figure) that are connected through a system bus. The processor A01 of the computer device is used to provide computing and control capacities. The memory of the computer device includes an internal memory A03 and a nonvolatile storage medium A06. The nonvolatile storage medium A06 stores an operation system B01 and a computer program B02. The internal memory A03 provides an environment for operation of the operation system B01 and the computer program B02 in the nonvolatile storage medium A06. The network interface A02 of the computer device is used to communicate with an external terminal through networking. The computer program implements the method for segmentation and clustering of a conglomerate reservoir when executed by the processor A01. The display screen A04 of the computer device may be a liquid crystal display screen or an electronic ink display screen. The input apparatus A05 of the computer device may be a touch layer covering the display screen, or may be a button, a trackball or a touch pad arranged on a shell of the computer device, or may be an external keyboard, a touch pad or a mouse.

It can be understood by those skilled in the art that the structure shown in FIG. 14 is merely a block diagram of some structure related to the solution of the disclosure, and does not constitute limitation to the computer device to which the solution of the disclosure is applied. The specific computer device may include more or less components than those shown in the figure, or combine some components, or have different component arrangements.

In an example, the apparatus for segmentation and clustering of a conglomerate reservoir according to the disclosure may be implemented as a computer program. The computer program may be run on the computer device shown in FIG. 14. The memory of the computer device may store the program modules that constitute the apparatus for segmentation and clustering of a conglomerate reservoir, such as the information obtainment module 410, the classification module 420, the segmentation module 430, the clustering module 440, and the result output module 450 shown in FIG. 13. The computer program composed of the program modules causes the processor to execute steps in the method for segmentation and clustering of a conglomerate reservoir of the examples of the disclosure described in this description.

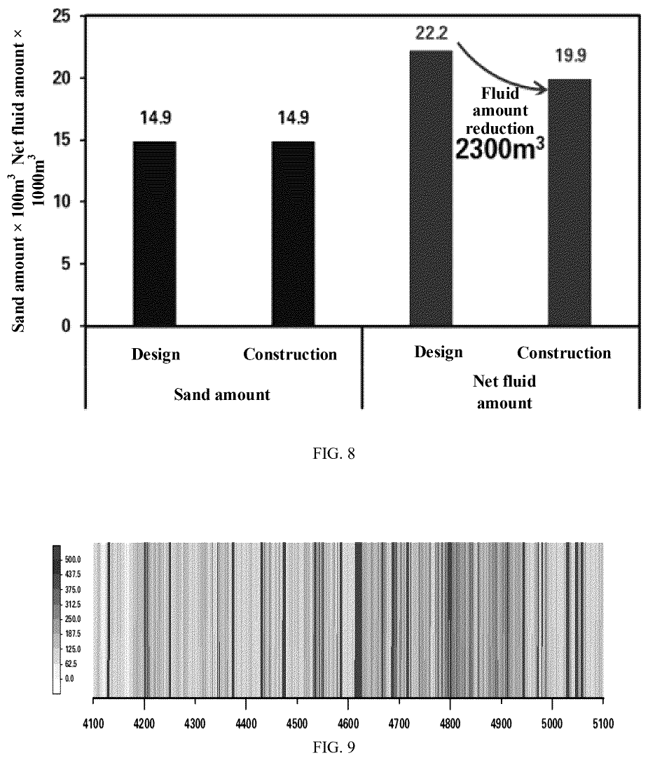

The computer device shown in FIG. 8 may execute step 210 through the information obtainment module 410 in the apparatus for segmentation and clustering of a conglomerate reservoir shown in FIG. 13. The computer device may execute step 220 through the classification module 420, execute step 230 through the segmentation module 430, execute step 240 through the clustering module 440, and execute step 250 through the result output module 450.

The example of the disclosure provides a device. The device includes a processor, a memory, and a program that is stored on the memory and runnable on the processor. When executing the program, the processor implements:
mechanical specific energy, geological parameter information, and engineering parameter information of the horizontal well are obtained;
multidimensional data classification is performed by using a clustering analysis algorithm on depth data points of a horizontal well according to the mechanical specific energy, the geological parameter information, and the engineering parameter information of the horizontal well, and a classification result is obtained;
a depth of the horizontal well is segmented by using the classification result and a preset horizontal segment length, and a segmentation result is obtained;
a comprehensive approach degree of geological engineering parameters at depths in segments in the segmentation result is computed by using an approach degree algorithm, and a perforation cluster position in each segment is obtained according to the comprehensive approach degree of the geological engineering parameters at the depths in the each segment; and
a segmentation and clustering result of the conglomerate reservoir is obtained according to the segmentation result and the perforation cluster position.

In an example, the step that mechanical specific energy of the horizontal well is obtained includes:
basic parameter information is obtained, where the basic parameter information includes at least drilling data and drilling tool assembly parameters; and
the mechanical specific energy of the horizontal well is computed by using a friction model of the horizontal well according to the basic parameter information.

In an example, the step that the mechanical specific energy of the horizontal well is computed by using a friction model of the horizontal well according to the basic parameter information includes:
the basic parameter information is plugged into a modified mechanical specific energy computation formula in the friction model of the horizontal well, and the mechanical specific energy of the horizontal well is obtained.

The modified mechanical specific energy computation formula is as follows:

$$E = \frac{4 P}{π {D}_{b}^{2} {e}^{{a}_{k} {μ}_{well}}} + \frac{240 q Δ {p}_{p} ( n + {K}_{N} Q )}{π {D}_{b}^{2} υ} + \frac{160 {μ}_{bit} {PD}_{b} ( n + {K}_{N} Q )}{{D}_{b}^{2} υ {e}^{{a}_{k} {μ}_{well}}} ,$$

in the formula, E denotes the mechanical specific energy of the horizontal well in unit of MPa, P denotes a weight on bit in unit of MPa, D_{b} denotes a diameter of a drill bit in unit of mm, e denotes a natural logarithm, αₖ denotes an angle of inclination in unit of rad, μ_{well} denotes a friction coefficient of a drill string, ν denotes a drilling speed in unit of m/h, q denotes a displacement per revolution of a drilling tool merely related to linear types and geometric dimensions of a stator and a rotor in unit of L/r, Δpₚ denotes a nozzle pressure drop of a screw drilling tool, in unit of MPa, n denotes a number of revolutions of a rotary table in unit of r/min, Mbit denotes a friction coefficient of the drill bit, K_{N} denotes a speed-flow ratio of a motor drilling tool in unit of r/L, and Q denotes a total flow in unit of L/s.

In an example, the steps that multidimensional data classification is performed by using a clustering analysis algorithm on depth data points of a horizontal well according to the mechanical specific energy, the geological parameter information, and the engineering parameter information of the horizontal well, and a classification result is obtained include:
S1: the mechanical specific energy, the geological parameter information, and the engineering parameter information of the horizontal well are preprocessed, and preprocessed data are obtained. The preprocessed data include a plurality of samples, and each sample includes the mechanical specific energy, the geological parameter information, and the engineering parameter information of the horizontal well;
S2: K centers are randomly selected from the depth data points of the horizontal well;
S3: a loss function is defined;
S4: a number of iterations is set;
S5: a distance between each sample and a clustering center is evaluated, and each sample is assigned to a cluster to which a nearest center belongs, and a clustering center point of each category is recomputed in a case that a loss condition or an iteration stop condition is not satisfied; and
S6: S5 is repeated until the loss function converges, and the classification result is obtained.

In an example, the steps that a depth of the horizontal well is segmented by using the classification result and a preset horizontal segment length, and a segmentation result is obtained include:
an initial segmentation point is obtained, the depth of the horizontal well is segmented according to the preset horizontal segment length from the initial segmentation point, and an initial segmentation result is obtained;
an identical label is assigned to data points that have an identical classification result in the segment according to classification results of data points in segments in the initial segmentation result, where labels corresponding to different classification results are different;
numbers of data points corresponding to labels in the segments in the initial segmentation result are counted;
a classification result corresponding to a label that corresponds to a maximum number of data points is taken as a majority point characteristic value within a segment length range of the each segment; and
the segmentation result is obtained according to majority point characteristic values within the segment length range of the segments.

In an example, the step that the segmentation result is obtained according to majority point characteristic values within the segment length range of the segments includes:
whether the majority point characteristic values within the segment length range of the segments fall into one category in the classification results is determined; if so, the initial segmentation result is taken as the segmentation result; and if not, the preset horizontal segment length is adjusted or/and the initial segmentation point is adjusted, resegmenting is performed, and the staging result is obtained.

In an example, the steps that a comprehensive approach degree of geological engineering parameters at depths in segments in the staging result is computed by using an approach degree algorithm, and a perforation cluster position in the segment is obtained according to the comprehensive approach degree of the geological engineering parameters at the depths include:
a fuzzy matter-element is established according to mechanical specific energy, geological parameter information, and engineering parameter information of the horizontal well of the segments;
preferred membership degrees of fuzzy variable values of evaluation indexes are computed based on a fuzzy variable value in the fuzzy matter-element according to a preferred membership degree principle;
a difference square compound fuzzy matter-element is established according to the preferred membership degrees of the fuzzy variable values of the evaluation indexes;
weights of characteristics are determined;
the difference square compound fuzzy matter-element and the weights of the characteristics are plugged into an approach degree computation formula, and the comprehensive approach degree of the geological engineering parameters at the depths in the segments is obtained; and the perforation cluster position in each segment is obtained according to the comprehensive approach degree of the geological engineering parameters at the depths in the each segment.

Those skilled in the art should understand that the examples of the disclosure may be provided as methods, systems, or computer program products. Thus, the disclosure may take the form of an entire hardware example, an entire software example, or an example combining software and hardware. Moreover, the disclosure may take the form of a computer program product implemented on one or more computer usable storage media (including but not limited to disk memories, compact disc read-only memories (CD-ROMs), and optical memories) including computer usable program codes.

The disclosure is described with reference to the flowchart and/or the block diagram of the method, the device (system), and the computer program product according to the example of the disclosure. It should be understood that computer program instructions may implement each flow and/or each block in the flowcharts and/or the block diagrams and a combination of a flow and/or a block in the flowcharts and/or the block diagrams. These computer program instructions may be provided for a processor of a general-purpose computer, a special-purpose computer, an embedded processing machine, or another programmable data processing device to produce a machine, such that instructions executed by the processor of the computer or another programmable data processing device generate an apparatus used for implementing a function specified in one or more flows of the flowchart and/or one or more blocks of the block diagram.

These computer program instructions may also be stored in a computer-readable memory that may guide the computer or another programmable data processing device to operate in a specific mode, such that the instructions stored in the computer-readable memory produce an article of manufacture including an instruction apparatus, and the instruction apparatus implements the function specified in one or more flows of the flowchart and/or one or more blocks in the block diagram.

These computer program instructions may alternatively be loaded onto the computer or another programmable data processing device, such that a series of operation steps are executed on the computer or another programmable device to generate computer-implemented processing, and instructions executed on the computer or another programmable device provide steps for implementing the function specified in the one or more flows of the flowchart and/or one or more blocks in the block diagram.

In a typical configuration, a computer device includes one or more central processing units (CPUs), an input/output interface, a network interface, and a memory.

The memory may include a non-permanent memory, a random access memory (RAM) and/or a nonvolatile memory in the computer-readable medium, such as a read-only memory (ROM) or a flash RAM. The memory is an instance of the computer-readable medium.

The computer-readable medium includes permanent or non-permanent, removable or non-removable media, and may store information by any method or technology. Information may be a computer-readable instruction, a data structure, a program module or other data. Examples of a computer storage medium include, but are not limited to, a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storages, a cassette tape, tape or disk storage or other magnetic storage devices, or any other non-transmission media that may be used to store information capable of being accessed by a computing device. According to the definitions herein, the computer-readable medium does not include transitory media, such as modulated data signals and carrier waves.

The examples described above are merely examples of the disclosure and are not used to limit the disclosure. It is apparent to a person of ordinary skill in the art that various modifications and changes can be made to the disclosure. Any modification, equivalent substitution, improvement, etc. made within the spirit and principles of the disclosure should fall within the scope of the claims of the disclosure.

1. A method for segmentation and clustering of a conglomerate reservoir, comprising:
obtaining mechanical specific energy, geological parameter information, and engineering parameter information of a horizontal well;
performing, by using a clustering analysis algorithm, multidimensional data classification on depth data points of the horizontal well according to the mechanical specific energy, the geological parameter information, and the engineering parameter information of the horizontal well, and obtaining a classification result;
segmenting a depth of the horizontal well by using the classification result and a preset horizontal segment length, and obtaining a segmentation result;
computing, by using an approach degree algorithm, a comprehensive approach degree of geological engineering parameters at depths in segments in the segmentation result, and obtaining a perforation cluster position in each segment according to the comprehensive approach degree of the geological engineering parameters at the depths in the each segment; and
obtaining a segmentation and clustering result of the conglomerate reservoir according to the segmentation result and the perforation cluster position.

2. The method according to claim 1, wherein obtaining mechanical specific energy of the horizontal well comprises:
obtaining basic parameter information, wherein the basic parameter information comprises at least drilling data and drilling tool assembly parameters; and
computing the mechanical specific energy of the horizontal well by using a friction model of the horizontal well according to the basic parameter information.

3. The method according to claim 2, wherein the computing the mechanical specific energy of the horizontal well by using a friction model of the horizontal well according to the basic parameter information comprises:
plugging the basic parameter information into a modified mechanical specific energy computation formula in the friction model of the horizontal well, and obtaining the mechanical specific energy of the horizontal well; wherein
the modified mechanical specific energy computation formula is as follows:
$$E = \frac{4 P}{π {D}_{b}^{2} {e}^{{a}_{k} {μ}_{well}}} + \frac{240 q Δ {p}_{p} ( n + {K}_{N} Q )}{π {D}_{b}^{2} υ} + \frac{160 {μ}_{b i t} P {D}_{b} ( n + {K}_{N} Q )}{{D}_{b}^{2} {υ e}^{{a}_{k} {μ}_{well}}} ,$$
wherein E denotes the mechanical specific energy of the horizontal well, P denotes a weight on bit, D_{b} denotes a diameter of a drill bit, e denotes a natural logarithm, αₖ denotes an angle of inclination, μ_{well} denotes a friction coefficient of a drill string, ν denotes a drilling speed, q denotes a displacement per revolution of a drilling tool, Δpₚ denotes a nozzle pressure drop of a screw drilling tool, n denotes a number of revolutions of a rotary table, μ_{bit} denotes a friction coefficient of the drill bit, K_{N} denotes a speed-flow ratio of a motor drilling tool, and Q denotes a total flow.

4. The method according to claim 1, wherein the performing, by using a clustering analysis algorithm, multidimensional data classification on depth data points of the horizontal well according to the mechanical specific energy, the geological parameter information, and the engineering parameter information of the horizontal well, and obtaining a classification result comprise:
S1: preprocessing the mechanical specific energy, the geological parameter information, and the engineering parameter information of the horizontal well, and obtaining preprocessed data, wherein the preprocessed data comprise a plurality of samples, and each sample comprises mechanical specific energy, geological parameter information, and engineering parameter information of the horizontal well;
S2: randomly selecting K centers from the depth data points of the horizontal well;
S3: defining a loss function;
S4: setting a number of iterations;
S5: evaluating a distance between each sample and a clustering center, and assigning each sample to a cluster to which a nearest center belongs, and recomputing a clustering center point of each category in a case that a loss condition or an iteration stop condition is not satisfied; and
S6: repeating S5 until the loss function converges, and obtaining the classification result.

5. The method according to claim 1, wherein the segmenting a depth of the horizontal well by using the classification result and a preset horizontal segment length, and obtaining a segmentation result comprises:
obtaining an initial segmentation point, segmentating the depth of the horizontal well according to the preset horizontal segment length from the initial segmentation point, and obtaining an initial segmentation result;
assigning, according to classification results of data points in segments in the initial segmentation result, an identical label to data points that have an identical classification result in the segment, wherein labels corresponding to different classification results are different;
counting numbers of data points corresponding to labels in the segments in the initial segmentation result;
taking a classification result corresponding to a label that corresponds to a maximum number of data points as a majority point characteristic value within a segment length range of the each segment; and
obtaining the segmentation result according to majority point characteristic values within the segment length range of the segments.

6. The method according to claim 5, wherein the obtaining the segmentation result according to majority point characteristic values within the segment length range of the segments comprises:
determining whether the majority point characteristic values within the segment length range of the segments fall into one category in the classification results; if so, taking the initial segmentation result as the segmentation result; and if not, adjusting the preset horizontal segment length or/and adjusting the initial segmentation point, performing resegmenting, and obtaining the segmentation result.

7. The method according to claim 1, wherein the computing, by using an approach degree algorithm, a comprehensive approach degree of geological engineering parameters at depths in segments in the segmentation result, and obtaining a perforation cluster position in each segment according to the comprehensive approach degree of the geological engineering parameters at the depths in the each segment comprise:
establishing a fuzzy matter-element according to mechanical specific energy, geological parameter information, and engineering parameter information of the horizontal well of the segments;
computing, based on a fuzzy variable value in the fuzzy matter-element, preferred membership degrees of fuzzy variable values of evaluation indexes according to a preferred membership degree principle;
establishing a difference square compound fuzzy matter-element according to the preferred membership degrees of the fuzzy variable values of the evaluation indexes;
determining weights of characteristics;
plugging the difference square compound fuzzy matter-element and the weights of the characteristics into an approach degree computation formula, and obtaining the comprehensive approach degree of the geological engineering parameters at the depths in the segments; and
obtaining the perforation cluster position in each segment according to the comprehensive approach degree of the geological engineering parameters at the depths in the each segment.

8. An apparatus for segmentation and clustering of a conglomerate reservoir, comprising:
an information obtainment module, configured to obtain mechanical specific energy, geological parameter information, and engineering parameter information of a horizontal well;
a classification module, configured to perform, by using a clustering analysis algorithm, multidimensional data classification on depth data points of the horizontal well according to the mechanical specific energy, the geological parameter information, and the engineering parameter information of the horizontal well, and obtain a classification result; a segmentation module, configured to segment a depth of the horizontal well by using the classification result and a preset horizontal segment length, and obtain a segmentation result;
a clustering module, configured to compute, by using an approach degree algorithm, a comprehensive approach degree of geological engineering parameters at depths in segments in the segmentation result, and obtain a perforation cluster position in each segment according to the comprehensive approach degree of the geological engineering parameters at the depths in the each segment; and
a result output module, configured to obtain a segmentation and clustering result of the conglomerate reservoir according to the segmentation result and the perforation cluster position.

9. (canceled)

10. A machine-readable storage medium, storing instructions, wherein the instructions cause a processor to execute the method for segmentation and clustering of a conglomerate reservoir according to claim 1 when executed by the processor.
